(19) United States
(12) Patent Application Publication
(10) Pub. No.: US 2015/0266385 A1
(43) Pub. Date: Sep. 24, 2015

(54) ENERGY TRANSMISSION DEVICE AND ENERGY TRANSMISSION ARRANGEMENT

(71) Applicant: ROBERT BOSCH GMBH, Stuttgart (DE)

(72) Inventor: Thomas Lang, Reutlingen (DE)

(21) Appl. No.: 14/434,855

(22) PCT Filed: Sep. 9, 2013
(86) PCT No.: PCT/EP2013/068608

§ 371 Date: Apr. 10, 2015

(30) Foreign Application Priority Data
Oct. 19, 2012 (DE) 102012219062.7

(51) Int. Cl. B60L 11/18; H02J 5/00

(52) U.S. Cl. CPC B60L 11/182; H02J 5/005

(57) ABSTRACT

The invention relates to an energy transmission device (10) for a vehicle (12) which has a wheel axle (22) and at least one wheel (14), wherein a wheel rim (16) of the wheel is mechanically coupled to the wheel axle by means of a connecting unit (18, 20), and wherein the wheel is designed to roll on an underlying surface in order to propel the vehicle, wherein the energy transmission device has a connecting unit (28) for connecting an electrical energy source or an electrical energy sink, and at least one transmission element (32) which is electrically coupled to the connecting unit and is designed to exchange, by means of wireless transmission of energy, electrical energy between the electrical energy source or energy sink and an external energy transmission unit arranged outside the vehicle, wherein the energy transmission device is connected to the wheel of the vehicle in a rotationally fixed fashion.

### BACKGROUND OF THE INVENTION

The present invention relates to an energy transmission device for a vehicle which has a wheel axle and at least one wheel, wherein a wheel rim of the wheel is mechanically coupled to the wheel axle by means of a connecting unit, and wherein the wheel is designed to roll on an underlying surface in order to propel the vehicle.

The present invention further relates to an energy transmission arrangement for a vehicle which has a wheel axle and at least one wheel, wherein the wheel is mechanically coupled to the wheel axle and is designed to roll on and underlying surface in order to propel the vehicle.

During an energy transmission, electrical energy is transmitted from an object to another one. Hence, an electrical cable can, for example, be used for the transmission. The option alternatively exists for the electrical energy to be transmitted with the aid of a wireless energy transmission. The wireless energy transmission results in a higher degree of mobility and avoids the problems of establishing an electrical contact. In so doing, user friendliness of the system can be increased.

The physical basis for the wireless energy transmission in the near-field region is either the capacitive or the inductive coupling.

In the capacitive energy transmission, sender and receiver field plates are disposed parallel to one another and thus form in each case a sheet capacitor. If an electrical load is coupled to the field plates, an alternating current can flow across the sheet capacitors that have been formed when an AC voltage is applied, and electrical power can thereby be transmitted to the electrical load. Inductive energy transmission systems are, however, for the most part significantly more efficient.

In an inductive energy transmission, an alternating magnetic field is generated on the primary side with the aid of a coil. At least a portion of this alternating magnetic field penetrates a secondary side, which likewise comprises a coil. As a result, a voltage is induced in the coil of the secondary side and therefore energy is transmitted from the primary side to the secondary side. The coupling factor of the two coupled coils forms an important characteristic variable in the inductive energy transmission. The coupling factor is defined by means of the ratio of the mutual inductances to the self-inductances of the coils. An increase in the coupling factor or, respectively, an improvement in the coupling between the coils can be achieved by the use of ferromagnetic materials, which, for example, are mounted above or below the coils and bundle the magnetic flux. As a result, the efficiency of the energy transmission can be improved.

In addition, the option exists for so-called resonance capacitors to be disposed on the primary side and the secondary side which form with the coils corresponding resonance circuits. If the capacitance values of the resonance capacitors are selected such that both resonance circuits are in resonance at the operating frequency, the effect of the inductances of the coils is cancelled. In so doing, the transmitted power can be maximized and the efficiency of the power transmission can be optimized. This resonant operation of the primary side and the secondary side is usually referred to as a magnetic resonance method. As a result of the resonance circuits used during the magnetic resonance method, the power transmission is however extremely frequency dependent.

Wireless energy transmission methods can, for example, be used for charging traction batteries of electrically driven vehicles. In known arrangements for four-wheeled vehicles (e.g. electric vehicles, hybrid vehicles), a sender coil is, for example, horizontally installed in the floor or on a mat. The receiver coil is situated horizontally in the underbody (car body) of the vehicle. It is known that the transmittable power of this system is directly dependent on the diameter of the coils and the wireless air gap to be bridged. The smaller that the coils are designed, the lower is the efficiency and therefore the smaller is the expedient bridgeable distance between the sender and the receiver coil. In addition, the coupling or, respectively, the efficiency of the energy transmission is affected by a horizontal offset of the two coils. For this reason, the sender and the receiver coil have, for example, an identical, relatively large diameter (for example 30 cm). Such an arrangement is not suitable for integration into two-wheeled vehicles having an open chassis (for example bicycles) due to the selected coil diameter.

Arrangements for two-wheeled vehicles are known, in which the sender coils are, for example, disposed in a floor mat and the receiver coil in a vehicle stand. In so doing, the receiver coils can only be implemented with a diameter of approximately 2 to 3 cm. As a result, the expedient transmission path is likewise only a few centimeters (for example 2 to 3 cm). This subsequently places high demands on the accuracy of positioning the sender and the receiver coil in both the vertical and lateral direction. If the sender and receiver coil are not positioned exactly with respect to one another, the coupling factor is reduced and with it the efficiency of the energy transmission. This exact positioning of the sender and receiver coil with respect to one another leads however to the user friendliness of the wireless energy transmission system being reduced.

### SUMMARY OF THE INVENTION

The present invention therefore provides an energy transmission device for a vehicle which has a wheel axle and at least one wheel, wherein a wheel rim of the wheel is mechanically coupled to the wheel axle by means of a connecting unit, and wherein the wheel is designed to roll on an underlying surface in order to propel the vehicle, wherein the energy transmission device has a connecting unit for connecting an electrical energy source or an electrical energy sink, and at least one transmission element which is electrically coupled to the connecting unit and is designed to exchange, by means of wireless transmission of energy, electrical energy between the electrical energy source or energy sink and an external energy transmission unit arranged outside the vehicle, wherein the energy transmission device is connected to the wheel of the vehicle in a rotationally fixed fashion.

The present invention furthermore provides an energy transmission arrangement for a vehicle which has a wheel axle and at least one wheel, wherein the wheel is mechanically coupled to the wheel axle and the wheel is designed to roll on an underlying surface in order to propel the vehicle, wherein the energy transmission arrangement comprises an inventive energy transmission device and an external energy transmission unit which is arranged outside the vehicle and is coupled inductively, capacitively or in a magnetically resonant manner to the energy transmission device for the purpose of transmitting electrical energy.

In contrast to the known energy transmission systems, the wheels or, respectively, the wheel rims of the vehicle are used for the disposal of the transmission element. In so doing, the option exists for, for example, even fraction batteries of two-wheeled vehicles with a high transmission capacity to be charged, wherein said vehicles do not have a floor assembly for accommodating larger receiver coils.

In addition, the energy transmission between the external energy transmission unit and the transmission element that is connected to the wheel of the vehicle in a rotationally fixed fashion can also be carried out when the wheels are rotating.

If the energy transmission device is mounted to a plurality of wheels of the vehicle, the transmittable power can be multiplied due to the larger effective total coil surface compared to a simply designed receiver coil in an underbody of the vehicle. In this regard, it is irrelevant whether the wheel used relates to a drive wheel of the vehicle or not.

Furthermore, the energy transmission device can be very universally used because said device is suited to all wheeled vehicles. Installation spaces of the vehicle are used for the energy transmission device which up until now were not intended for a disposal of transmission elements. By means of the inventive disposal of the transmission element in the wheel of the vehicle, a very compact design of the energy transmission device can be achieved.

In one embodiment, the connecting unit comprises a wheel hub, wherein the connecting unit for connecting an electrical energy source or an electrical energy sink is disposed on the wheel hub.

The connecting element is used for connecting the electrical energy source or the electrical energy sink. For example, the traction battery of an electrically driven vehicle can be connected to the connecting unit in order to charge said traction battery with electrical energy. By disposing the connecting unit on the wheel hub, the electrical contact to the traction battery, which is installed in a frame or a body of the vehicle, can be very easily established.

In a further embodiment, the connecting unit has a plurality of spokes, wherein the energy transmission device has an electrical line which is disposed in one of the spokes and electrically couples the transmission element to the connecting unit.

The disposal of the electrical line in one of the spokes provides a solution that is constructively very simple and reliable for the electrical contacting between the transmission element and the connecting unit. No additional mechanical elements, which would increase the weight of the wheel, are thereby necessary for guiding electrical lines.

The energy transmission device can also comprise a plurality of electrical lines, which are disposed in the plurality of spokes, for the electrical contacting between the transmission element and the connecting unit.

According to a further embodiment, the transmission element can be coupled inductively, capacitively or in a magnetically resonant manner to the external energy transmission unit for the purpose of transmitting energy.

Because the transmission element can be configured in various geometries in the wheel of the vehicle, an inductive, magnetic resonant or capacitive transmission method can be implemented using the energy transmission device according to the invention.

In a further embodiment, the transmission element is disposed on or in the wheel rim.

By arranging, for example, coils in a bicycle wheel rim having a rim diameter of 28 inches (622 mm), a high power output can be transmitted due to the large coil surface. Besides the inductive transmission method, transmission methods with a lower energy density (for example magnetic resonance methods) can furthermore also be implemented for a two-wheeled vehicle. In the known systems, the application of such methods fail because larger coils have to be used, which to date could not be installed in two-wheeled vehicles, due to the lower energy density.

The generally higher power density of the energy transmission device according to the invention furthermore enables the distance between the transmission element and the external energy transmission unit to be greater, whereby the user friendliness is increased for the user.

According to a further embodiment, the transmission element is disposed on the connecting unit in the vicinity of the wheel axle.

By means of such a disposal, the inertia forces caused by the transmission element can be reduced.

In a further embodiment, the transmission element is disposed in a cross-sectional plane of the wheel, wherein the wheel axle lies in the cross-sectional plane.

By disposing the transmission element in the cross section of the wheel, the external energy transmission unit can be variously positioned with respect to the vehicle. Depending on the wheel position, the external energy transmission unit can, for example, be disposed under the vehicle, on the side of the vehicle or in front of/behind the vehicle. In addition, further transmission elements can also be disposed in further cross-sectional planes of the wheels. For example, a second coil can be provided as a transmission element, which is disposed perpendicularly to a first coil. These leads to a plurality of wheel positions in which an efficient energy transmission can take place,

In a further embodiment, the transmission element comprises a coil.

Various geometries can be implemented for the coil. The coil can, for example, have a round or a rectangular cross-sectional surface. Ferromagnetic materials can furthermore be used which are, for example, mounted above or below the coils and which bundle the magnetic flux in order to thereby achieve an improvement in the coupling between the coil of the transmission element and a coil of the external energy transmission unit.

In a further embodiment, a longitudinal axis of the coil is disposed parallel to the wheel axis.

In this embodiment, the coil is disposed radially symmetrically on/in the wheel rim. In so doing, ferrite plates or cores for reinforcing the magnetic field can be disposed on/in the wheel rim. A large power output can be transmitted due to the large cross-sectional surface of the coil of the transmission element.

In a further embodiment, a longitudinal axis of the coil is disposed tangentially to a circle around the wheel axis.

The option thereby exists for one or a plurality of coils to be used for the energy transmission. The coils can, for example, be implemented on/in the wheel rim. In so doing, an installation space between the rim and the tire, which is already present and unused until now, is used for the disposal of the coils. The coils can also alternatively be disposed in the vicinity of the hub in order to reduce the inertia forces of the wheel.

According to a further embodiment, the energy transmission device comprises a magnetic sensor, which is designed to detect an orientation and/or a strength of a magnetic field.

With the aid of the magnetic sensor, the magnetic field formed for the energy transmission can be exactly determined. As a result, the option, for example, exists for the orientation of the energy transmission device to change in order to increase the efficiency of the energy transmission.

According to a further embodiment, the transmission element comprises a capacitor plate.

In this embodiment, the transmission element is capacitively coupled to the external energy transmission unit. The capacitor plate is preferably disposed in the vicinity of the hub/rotational axis of the wheel in order to reduce the inertia forces. In order to increase the capacitance, a plurality of capacitor plates can also be provided, which are connected in parallel.

According to a further embodiment, the energy transmission device has a position sensor which is designed to detect a position of the wheel.

With the aid of the position sensor, a precise positioning of the transmission element with respect to the external energy transmission unit can be ensured. As a result, a high degree of efficiency of the energy transmission is achieved.

In a further embodiment, the energy transmission device has a control unit which is electrically coupled to the connecting unit and is designed to control the energy transmission.

A very compact design of the energy transmission device is achieved by means of the additional integration of the control unit. Said control unit is preferably positioned in the vicinity of the hub in order to minimize the inertia forces of the wheel. Said control unit can furthermore be coupled to the position sensor and to the magnetic sensor, which determines the strength of the magnetic field, in order to control the energy transmission as a function of signals of both sensors.

In one embodiment of the energy transmission arrangement, the energy transmission device is electrically coupled to a traction battery of the vehicle and the energy transmission unit to an electrical energy supply network. The external energy transmission unit is designed to transmit electrical energy to the energy transmission device in order to charge the traction battery.

This constitutes a preferred embodiment of the energy transmission arrangement according to the invention. The power density of the transmission is increased by the inventive disposal of the energy transmission device in the wheel of the vehicle. This makes a greater distance possible between the energy transmission device and the external energy transmission unit. As a result, the user friendliness of the energy transmission arrangement is improved. In addition, the higher power density ensures a faster charging process of the traction battery.

It goes without saying that the features, characteristics and advantages of the inventive energy transmission device also correspondingly relate to or can be applied to the inventive energy transmission arrangement.

### BRIEF DESCRIPTION OF THE DRAWINGS

FIGS. 1a, 1b, 2, 3, 4a, 4b, 5, 6, 7a, 7b, 8 and 9 show different embodiments of an energy transmission device for an electrically driven vehicle which can be coupled inductively or in a magnetically resonant manner to an external energy transmission unit; and

FIG. 10 shows an embodiment of the energy transmission device for an electrically driven vehicle which can be capacitively coupled to the external energy transmission unit.

### DETAILED DESCRIPTION

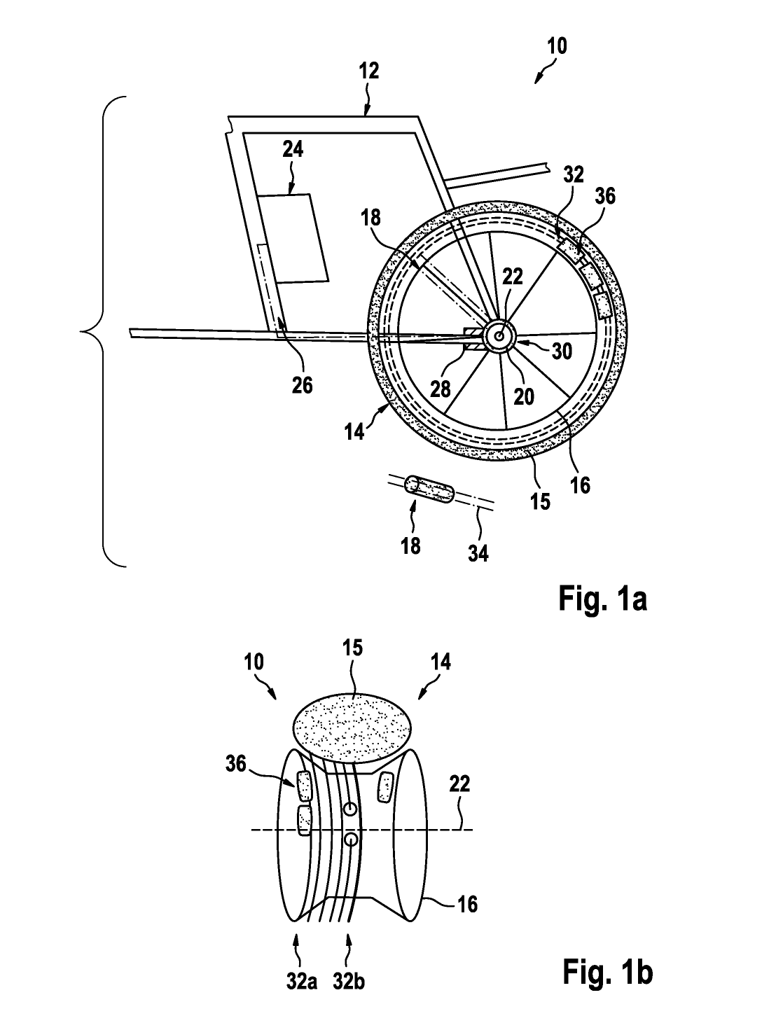

An embodiment of an inventive energy transmission device 10 for an electrically driven vehicle 12 is depicted in FIG. 1a. In the present case, the electrically driven vehicle 12 is an electrically driven bicycle (E-bike). The bicycle 12 has two wheels 14, wherein only one wheel 14 is depicted in FIG. 1a for reasons of clarity. The bicycle 14 has a tire 15 which is fit to a wheel rim 16. The wheel rim 16 is connected via a plurality of spokes 18 to the wheel hub 20, which establishes a mechanical coupling to a wheel axle 22 of the bicycle 12.

Because the present example relates to an electrically driven bicycle 12, the bicycle 12 has a traction battery 24 which provides electrical energy for driving said bicycle 12. To this end, the traction battery 24 is connected via a wiring harness 26 to a connecting unit 28 which establishes the electrical contact to a wheel hub motor 30. The wheel hub motor 30 drives the bicycle 12 with the aid of energy supplied by the traction battery 24.

After a certain operating time of the bicycle 12, the fraction battery 24 has to be recharged with electrical energy. To this end, the bicycle 12 has the energy transmission device 10 according to the invention which is designed to feed transferred electrical energy into the wiring harness 26 by means of a wireless energy transmission and thereby charge the traction battery 24. The energy transmission device 10 is connected to the wheel 14 of the bicycle 12 in a rotationally fixed fashion. The energy transmission device 10 comprises a transmission element 32, in the present case a coil 32. The coil 32 is coupled via at least one electrical line 34 to the connecting unit 28 which is disposed on the wheel hub 20.

The electrical line 34 is advantageously configured in one of the spokes 18. A voltage induced in the coil 32 due to an alternating magnetic field or a current induced in the coil 32 can therefore be transmitted further via the electrical line 34, the connecting unit 28 and the wiring harness 26 to the traction battery 24. As a result, the traction battery 24 can be charged with electrical energy due to a magnetic field acting on the coil 32. In this exemplary embodiment, the coil 32 is radially symmetrically disposed on the wheel rim 16. In other words, a longitudinal axis of the coil 32 is disposed parallel to the wheel axle 22.

In order to strengthen or, respectively bundle the magnetic field, ferrite plates/cores 36 are disposed on the wheel rim 16. By means of the inventive disposal of the coil 32 on the wheel rim 16, the coil 32 has a larger diameter. As a result, a high power density can be achieved during the energy transmission. The energy transmission illustrated in FIG. 1a is thereby based, for example, on an inductive transmission method, in which only one coil is, for example, used.

In the following figures, further embodiments of the energy transmission device 10 according to the invention are depicted, which are all based on the principle that the energy transmission device 10 is connected to the wheel 14 of the vehicle 12 in a rotationally fixed fashion. Identical elements with regard to preceding embodiments are therefore denoted by the same reference signs. The differences are substantially explained in regard to the sequential figures.

A further embodiment of the energy transmission device 10 is depicted in FIG. 1b, which is based on the magnetic resonance method. To this end, two coils 32a, 32b are disposed on the wheel rim 16, which, for example, have a different number of windings. As can be seen in FIG. 1b, the coils 32a, 32b are disposed radially symmetrically with respect to the wheel rim 16 and therefore use an installation space between the wheel rim 16 and the tire 15. This leads to the very compact design thereof.

In an alternative embodiment, the coils 32a, 32b and/or the ferrite plates 36 can be designed in the wheel rim 16.

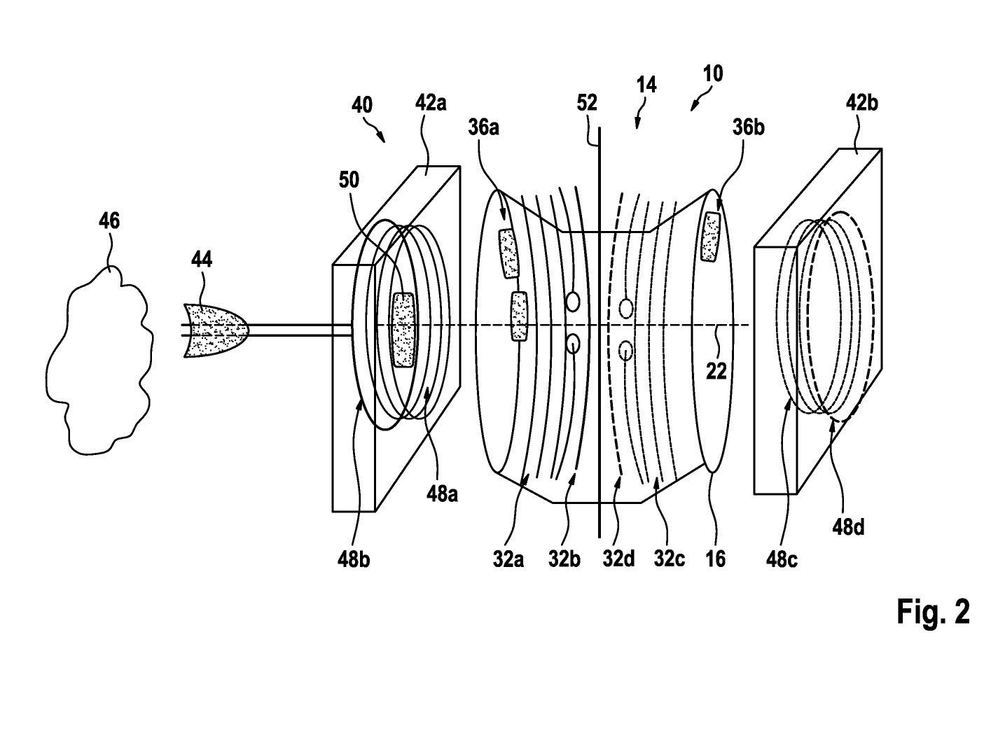

An energy transmission arrangement 40, which comprises the energy transmission device 10 and an external energy transmission unit 42a, 42b arranged outside the vehicle 12, is depicted in FIG. 2. The external energy transmission unit 42a, 42b is coupled via a plug contact 44 to an energy supply network 46 and is designed to transmit electrical energy from the energy supply network 46 to the energy transmission device 10 by means of a wireless energy transmission method. In the exemplary embodiment illustrated in FIG. 2, the external energy transmission unit 42 is coupled inductively or in a magnetically resonant manner to the energy transmission device 10. To this end, the energy transmission unit 42 has the coils 48 which can, for example, have a different number of windings. In order to increase or bundle the magnetic field, a ferrite core 50 can be disposed in the region of the coils 48. In an advantageous manner, the coils 48 are thereby disposed substantially parallel to the wheel rim 16. The coils 32 of the energy transmission device 10 can likewise have different numbers of windings.

In order to transmit a large amount of energy, the energy transmission device 10 and the energy transmission unit 42 are designed symmetrically to a plane of symmetry 52 depicted in FIG. 2.

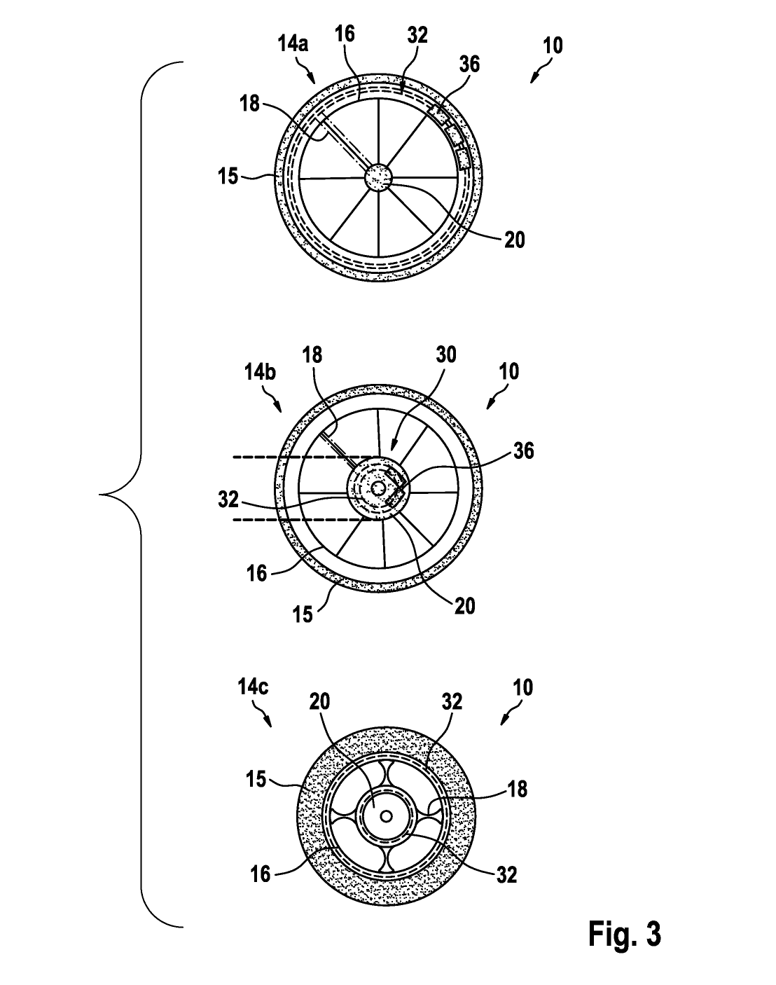

In FIG. 3, further embodiments of the energy transmission device 10 are shown in which the coil 32 is disposed at different locations of the wheel 14. The coil 32 is thus positioned in the wheel 14a on/in the wheel rim 16. In the wheel 14b, the coil 32 is in contrast configured on the wheel hub motor 30. In the case of wheel 14c, the coil 32 is implemented on/in the wheel rim 16 and/or in the vicinity of the wheel hub 20. It can be seen in FIG. 3 that the coil 32 can be very flexibly positioned in the wheel 14.

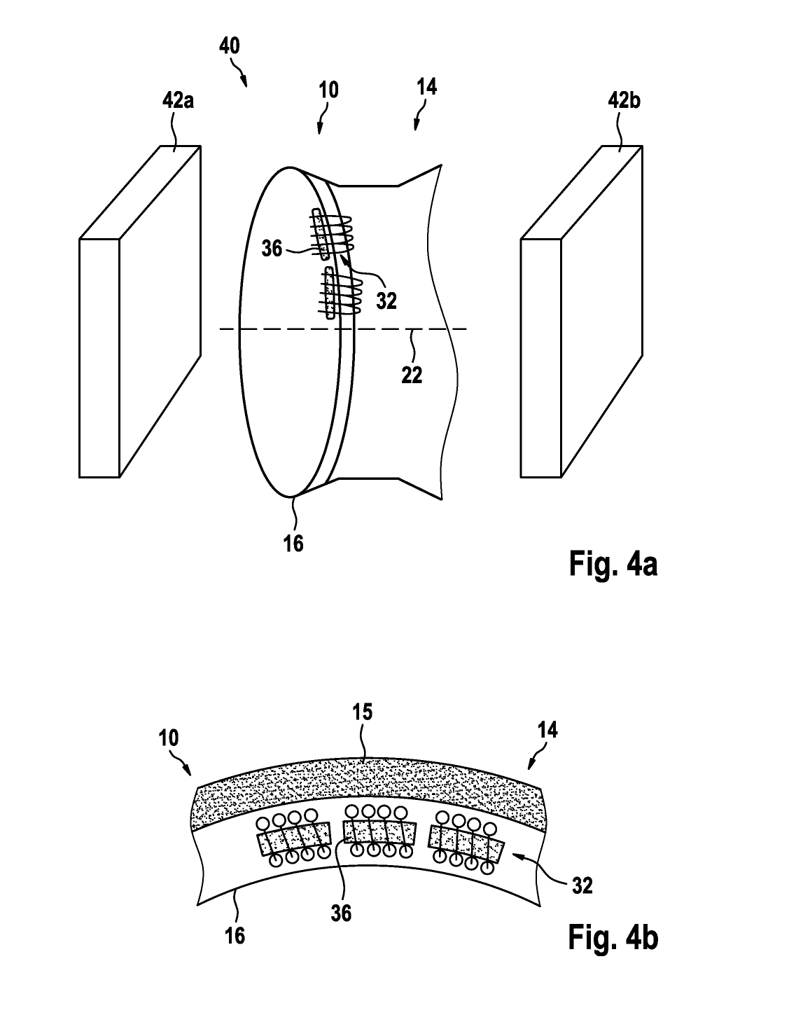

FIG. 4a illustrates a further embodiment of the energy transmission arrangement 40 and the energy transmission device 10. In this embodiment, the coils 32 are disposed tangentially on/in the wheel rim 16. In other words, a longitudinal axis of the respective coil 32 is disposed tangentially to a circle around the wheel axle 22. In order to increase the magnetic field, ferrite plates 36 can be installed in the vicinity of the coils 32. The energy transmission of the energy transmission arrangement 40 is based on an inductive or magnetic resonant coupling between the energy transmission unit 42 and the energy transmission device 10.

In FIG. 4b, a cross section of the wheel 14 is shown from the exemplary embodiment depicted in FIG. 4a. As can be seen in FIG. 4b, a plurality of coils 32 can be positioned tangentially to the wheel rim 16. The ferrite cores 36 can, for example, be positioned in the vicinity of a coil axis.

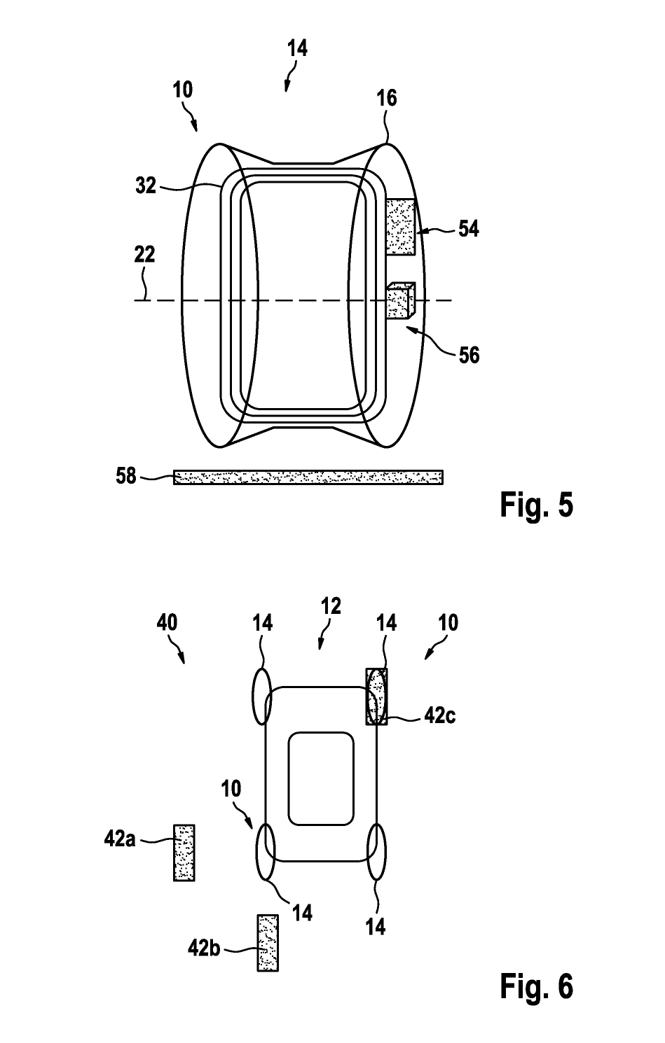

A further embodiment of the energy transmission device 10 is depicted in FIG. 5, in which the coil 32 is disposed in a cross section of the wheel rim 16. A ferrite core 36 can also be disposed in the vicinity of the coil 32 in this embodiment in order to increase the magnetic field. The electrical contacting of the coil 32 takes place in turn via the electrical line 34, which is not depicted in FIG. 5 and which establishes the electrical connection, for example, to the traction battery 24. In addition, the energy transmission device 10 from FIG. 5 comprises a control unit 54, in the present case a charging device 54, and a position sensor 56. The charging device 54 is designed to control the charging process of the traction battery 24. The position sensor 56 is designed to detect a position of the wheel 14. The coil 32 can therefore be aligned by means of the position sensor 56, for example, perpendicularly or horizontally to an underlying surface 58. In so doing, the efficiency of the energy transmission between the energy transmission device 10 and the energy transmission unit 42 can be optimized.

Due to the disposal of the coil 32 in the cross section of the wheel rim 16 and the wheel position detection using the position sensor 56, the energy transmission unit 42 can be disposed at different positions relative to the vehicle 12. This is depicted in FIG. 6. The energy transmission unit 42a can, for example, be positioned laterally with respect to the vehicle 12. The energy transmission unit 42 can alternatively or additionally be disposed in front of/in back of or under the vehicle (see reference signs 42b, 42c). If the energy transmission device 10 and the energy transmission unit 42 are provided on each of the wheels 14 of the four-wheeled vehicle 12 from FIG. 6, the charging capacity can be increased to the fourfold value.

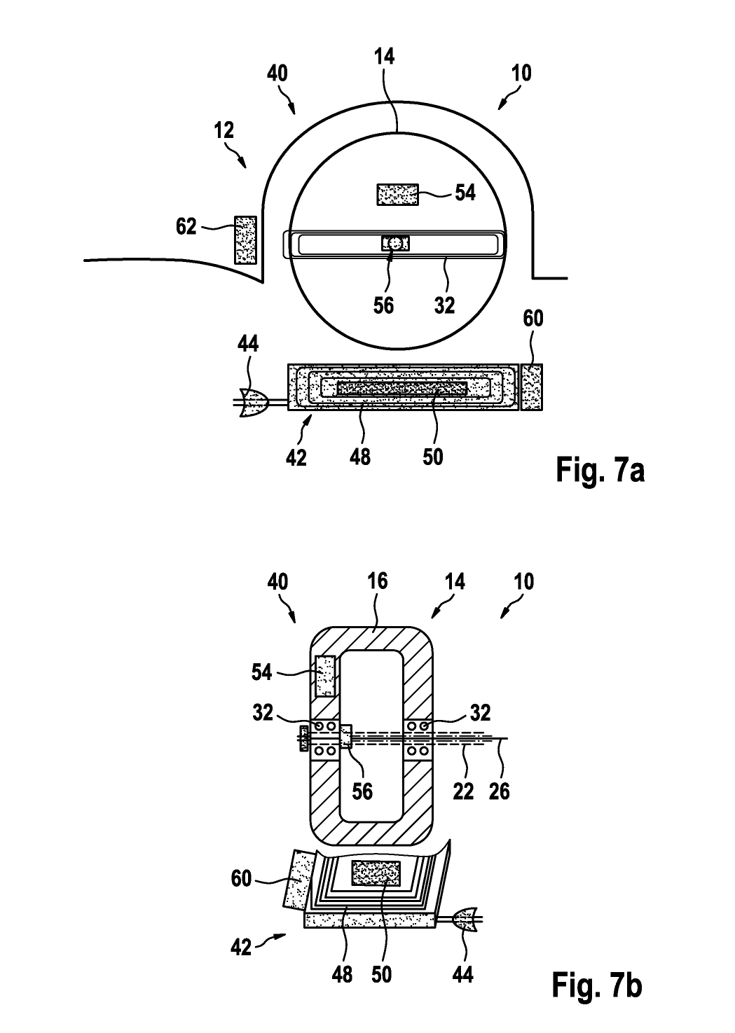

A further embodiment of the energy transmission arrangement 40 is depicted in FIG. 7a. In this case, the energy transmission unit 42 comprises an external control device 60 which can be used for the sender-side control of the sender coils 48. The energy transmission arrangement additionally comprises a magnetic sensor 62 which is installed in a body of the vehicle 12 and is designed to detect an orientation/strength of the magnetic field. The signals provided by the magnetic sensor 62 and the position sensor 56 can, for example, be evaluated by the charging device 54 in order to detect a charging readiness of the energy transmission arrangement 40 and/or improve the efficiency of the energy transmission. A ferrite disc 50 or a ferrite core 50 is optionally used to bundle the magnetic field.

FIG. 7b shows a cross section of the wheel 14 to illustrate a further embodiment of the energy transmission arrangement 40. As can be seen in FIG. 7b, the charging device 54 is disposed within the wheel rim 16. The coils 32 and the position sensor 56 are positioned in the vicinity of the wheel axle 22. The electrical contacting of the coils 32 takes place via the wiring harness 26 which is guided within the wheel axle 22.

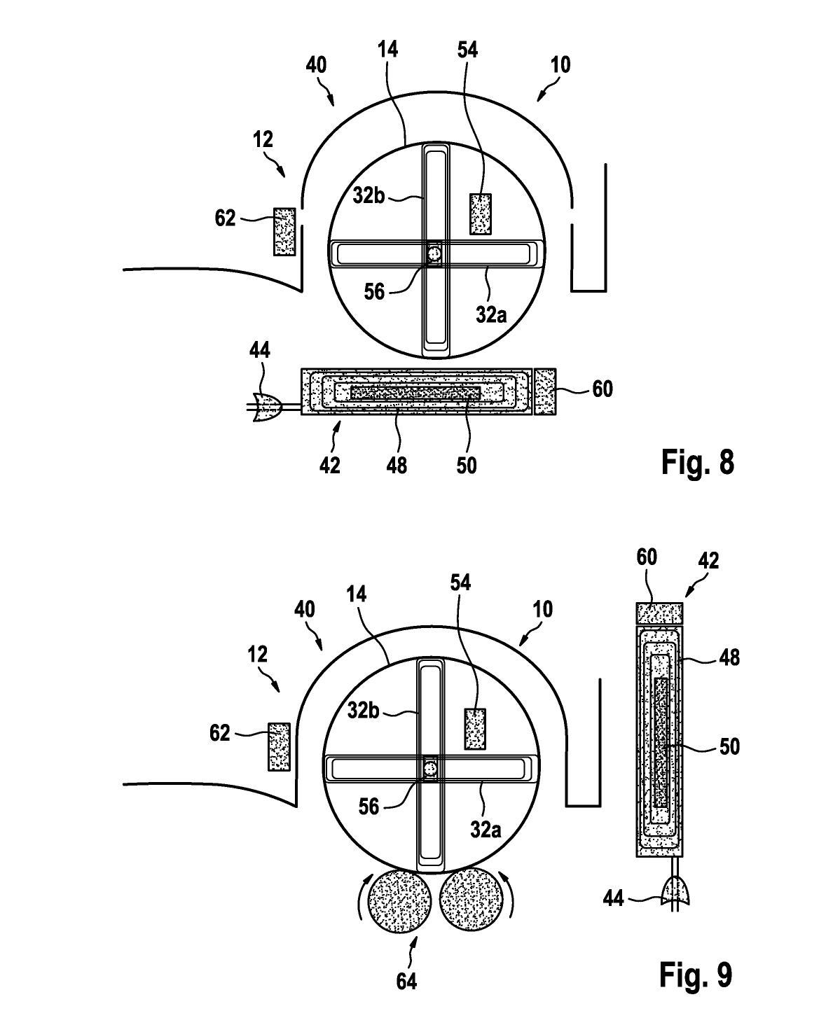

In the embodiment of the energy transmission arrangement 40 depicted in FIG. 8, two coils 32a, 32b are configured in the cross section of the wheel 14 or, respectively, in the cross section of the wheel rim 16. In so doing, the coil 32b is oriented perpendicularly to the coil 32a. Hence, a plurality of charging positions of the wheel 14 arise as a result, in which an efficient energy transmission is enabled. In addition, the option exists for the coils 32a, 32b to be operated separately of one another by means of correspondingly disposed energy transmission units 42.

In FIG. 9, the wheel 14 is arranged on a track roller 64. The vehicle 12 can thereby be operated on the track roller 64, wherein the traction battery 24 of the vehicle is simultaneously charged. Such a charging option of the traction battery 24 results, for example, during a final inspection in the manufacturing process, during maintenance at a service center or during a technical check of the vehicle 12.

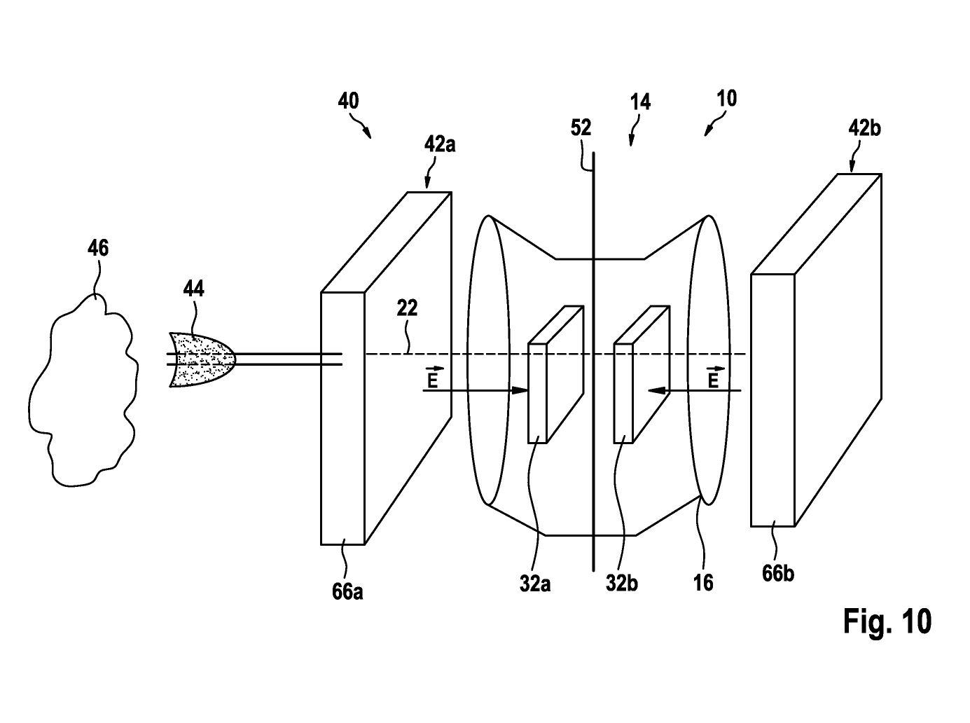

In FIG. 10, an embodiment of the energy transmission arrangement 40 is shown, which is based on a capacitive coupling between the energy transmission unit 42a, 42b and the energy transmission device 10. To this end, the transmission element 32a is designed as a field plate/capacitor plate 32a, 32b. The field plate 32a, 32b is preferably disposed in the wheel 14 or, respectively, in the wheel rim 16 in the vicinity of the wheel axle 22. The energy transmission unit 42a, 42b has correspondingly a field plate 66a, 66b which together with the field plate 32a, 32b forms a capacitor arrangement. The field plate 66a, 66b is preferably oriented substantially parallel to the field plate 32a, 32b. During operation of the energy transmission arrangement 40, an electrical field develops between the field plates 66, 32, said electrical field being designated in FIG. 10 by the vector E.

Instead of the one field plate 32a shown in FIG. 10, a plurality of field plates can also alternatively be installed side by side, said field plates then being connected in parallel in order to increase the capacitor surface and therefore the electrical capacity. Moreover, the field plates 32 can be of round or rectangular configuration.

In order to increase the transmittable power of the energy transmission arrangement 40, the energy transmission device 10 and the energy transmission unit 42 can be designed symmetrically to the plane of symmetry 52 shown in FIG. 10. In this arrangement, the field plates 32 are preferably protected on the surface facing away from the main field against stray fields of the plates lying on the other side of the plane of symmetry 52 by a suitable insulating material or a corresponding coating.

Although preferred embodiments of the inventive energy transmission device 10 and the inventive energy transmission arrangement 40 have thus been shown, it goes without saying that different variations and modifications can be undertaken without departing from the scope of the invention.

The energy transmission device 10 can, for example, be installed in any vehicles which have at least one wheel.

In addition, electrical energy from the vehicle 12 can also, for example, be fed into an energy supply network 46 using the energy transmission device 10.

With regard to the energy transmission device 10, a plurality of different embodiments can furthermore be combined with one another.

1. An energy transmission device (10) for a vehicle (12) which has a wheel axle (22) and at least one wheel (14), wherein a wheel rim (6) of the wheel (14) is mechanically coupled to the wheel axle (22) by a connecting device (18, 20), and wherein the wheel (14) is configured to roll on an underlying surface in order to propel the vehicle (12), the energy transmission device comprising:
a connecting unit (28) for connecting an electrical energy source or an electrical energy sink, and
at least one transmission element (32) which is electrically coupled to the connecting unit (28) and is configured to exchange, by wireless transmission of energy, electrical energy between the electrical energy source or energy sink and an external energy transmission unit (42) arranged outside the vehicle (12),
wherein the energy transmission device (10) is connected to the wheel (14) of the vehicle (12) in a rotationally fixed fashion.

2. The energy transmission device according to claim 1, wherein the connecting device (18, 20) has a plurality of spokes (18), and wherein the energy transmission device (10) has an electrical line (34) which is disposed in one of the spokes (18) and electrically couples the transmission element (32) to the connecting unit (28).

3. The energy transmission device according to claim 1, wherein the transmission element (32) is configured to be coupled inductively, capacitively or in a magnetically resonant manner to the external energy transmission unit (42) for the purpose of transmitting the energy.

4. The energy transmission device according to claim 1, wherein the transmission element (32) is disposed on or in the wheel rim (16).

5. The energy transmission device according to claim 1, wherein the transmission element (32) is disposed on the connecting unit in the vicinity of the wheel axle (22).

6. The energy transmission device according to claim 1, wherein the transmission element (32) is disposed in a cross-sectional plane of the wheel (14), and wherein the wheel axle (22) lies in the cross-sectional plane.

7. The energy transmission device according to claim 1, wherein the transmission element (32) has a coil.

8. The energy transmission device according to claim 7, wherein a longitudinal axis of the coil is disposed parallel to the wheel axle (22).

9. The energy transmission device according to claim 7, wherein a longitudinal axis of the coil is disposed tangentially to a circle around the wheel axle (22).

10. The energy transmission device according to claim 1, wherein the energy transmission device (10) has a magnetic sensor (62) which is configured to detect at least one of an orientation and a strength of a magnetic field.

11. The energy transmission device according to claim 1, wherein the transmission element (32) comprises a capacitor plate.

12. The energy transmission device according to claim 1, wherein the energy transmission device (10) comprises a position sensor (56) which is configured to detect a position of the wheel (14).

13. The energy transmission device according to claim 1, wherein the energy transmission device (10) comprises a control unit (54) which is electrically coupled to the connecting unit (28) and is configured to control the energy transmission.

14. An energy transmission arrangement (40) for a vehicle (12) which has a wheel axle (22) and at least one wheel (14), wherein the wheel (14) is mechanically coupled to the wheel axle (22) and is configured to roll on an underlying surface in order to propel the vehicle (12), the energy transmission arrangement comprising:
an energy transmission device (10) including a connecting unit (28) for connecting an electrical energy source or an electrical energy sink, and at least one transmission element (32) which is electrically coupled to the connecting unit (28) and is configured to exchange, by wireless transmission of energy, electrical energy between the electrical energy source or energy sink and an external energy transmission unit (42) arranged outside the vehicle (12), wherein the energy transmission device (10) is connected to the wheel (14) of the vehicle (12) in a rotationally fixed fashion, and
an energy transmission unit (42) which is arranged outside the vehicle (12) and is coupled inductively, capacitively or in a magnetically resonant manner to the energy transmission device (10) for the purpose of transmitting electrical energy.

15. The energy transmission arrangement according to claim 14, wherein the energy transmission device (10) is electrically coupled to a traction battery (24) of the vehicle (12), and wherein the external energy transmission unit (42) is electrically coupled to an energy supply network (46) and is configured to transmit electrical energy to the energy transmission device (10) in order to charge the traction battery (24).

16. A for a vehicle (12) comprising:
a wheel axle (22) and at least one wheel (14), wherein the wheel (14) is mechanically coupled to the wheel axle (22) and is configured to roll on an underlying surface in order to propel the vehicle (12); and
an energy transmission arrangement including
an energy transmission device (10) including a connecting unit (28) for connecting an electrical energy source or an electrical energy sink, and at least one transmission element (32) which is electrically coupled to the connecting unit (28) and is configured to exchange, by wireless transmission of energy, electrical energy between the electrical energy source or energy sink and an external energy transmission unit (42) arranged outside the vehicle (12), wherein the energy transmission device (10) is connected to the wheel (14) of the vehicle (12) in a rotationally fixed fashion, and
an energy transmission unit (42) which is arranged outside the vehicle (12) and is coupled inductively, capacitively or in a magnetically resonant manner to the energy transmission device (10) for the purpose of transmitting electrical energy.

17. The vehicle according to claim 16, wherein the energy transmission device (10) is electrically coupled to a traction battery (24) of the vehicle (12), and wherein the external energy transmission unit (42) is electrically coupled to an energy supply network (46) and is configured to transmit electrical energy to the energy transmission device (10) in order to charge the traction battery (24).
